(19) United States
(12) Patent Application Publication
(10) Pub. No.: US 2026/0331352 A1
(43) Pub. Date: Oct. 22, 2026

(54) INDUCTIVE COMPONENT AND METHOD FOR MANUFACTURING AN INDUCTIVE COMPONENT

(71) Applicant: BOURNS, INC., Riverside, CA (US)

(72) Inventors: Carsten Schwetje, Göttingen (DE); Jens Gunkel, München (DE); Adrian Pickel, Hann. Münden (DE); Ricardo Landschoof-Schulz, Göttingen (DE); Enrique Luca Dodoli-Subklewe, Hann. Münden (DE); Julian Eggers, Göttingen (DE); Olaf Niemann, Schöm (DE)

(21) Appl. No.: 19/654,213

(22) Filed: Apr. 21, 2026

(30) Foreign Application Priority Data
Apr. 22, 2025 (DE) 10 2025 115 409.0

(51) Int. Cl. H01F 27/24; H01F 27/28; H01F 41/02; H01F 41/04

(52) U.S. Cl. CPC H01F 27/24; H01F 27/28; H01F 41/0206; H01F 41/04

(57) ABSTRACT

An inductive component comprising a first magnetic core, a second magnetic core arranged adjacent to the first magnetic core, and a conductor laid around the first magnetic core and the second magnetic core in an open periodically curved geometry with at least one inflection point, such that, in the event of an electric current flowing through the conductor, the magnetic flux direction in the second magnetic core is oriented opposite to that in the first magnetic core.

### RELATED APPLICATIONS

This application claims the benefit of German Patent Application No. DE 10 2025 115 409.0, filed Apr. 22, 2025, the entire content of which is hereby incorporated by reference.

### BACKGROUND OF THE INVENTION

The present invention relates to an inductive component and to a method for manufacturing an inductive component.

Inductive components of the generic type are known, for example, from EP 2 067 148 B1 in the form of a flat coil.

It is an object of the invention to improve known inductive components.

### BRIEF SUMMARY OF THE INVENTION

According to one aspect of the invention, an inductive component comprises a first magnetic core, a second magnetic core arranged adjacent to the first magnetic core, and a conductor laid around the first and second magnetic cores in an open periodically curved geometry with at least one inflection point, such that, in the event of an electric current flowing through the conductor, the magnetic flux direction in the second magnetic core is oriented opposite to that in the first magnetic core.

The stated inductive component is based on the consideration that, in conventional inductive components, such as the flat coil cited at the outset, problems increasingly arise, in particular at increasing frequencies, higher currents, and more complex requirements. Long winding paths lead to high electrical losses caused by undesired parasitic effects, such as higher ohmic losses, which impair the performance and efficiency of such components. In addition, long conductor tracks lead to increased leakage inductances and thermal challenges, since the power loss is locally strongly concentrated and thus effective heat dissipation is made more difficult.

The stated inductive component addresses this with the idea of not guiding the conductor completely around a single, large magnetic core, but rather guiding its winding in an open, periodically curved geometry with at least one inflection point between at least two separate magnetic cores arranged next to one another. The idea behind this is that, in the event of an electric current flowing through the conductor, conductor sections of adjacent windings act on both magnetic cores and thus, at the same time, one conductor section can be used for two windings, with the result that the entire conductor length necessary for the inductive component is reduced.

In this way, the electrical conductor length is minimized by shorter winding paths, which directly leads to a reduction in electrical losses. Parasitic effects, such as undesired inductances and capacitances, are also reduced by the optimized conductor routing, whereby in particular high-frequency properties are improved. From a thermal point of view, the distributed arrangement of the magnetic cores also offers advantages, since the power loss is distributed better spatially and less heat is generated locally, which leads to improved thermal stability. Finally, the modular construction enables simple scalability and adaptation to different electrical and mechanical requirements.

In a further development, the stated inductive component comprises a further conductor laid parallel to the conductor around the first and second magnetic cores, so that a transformer is formed. In this way, in addition to pure storage or limitation of energy, electrical energy can also be transferred in a targeted manner between two or more electrical circuits and, in the process, voltages as well as currents can be adapted modularly, because, by the number of magnetic cores, it can be expanded as desired by simple concatenation of further separate magnetic cores and thus the transformation ratio can be adapted in a simple manner solely by variation of the number and arrangement of the individual segments. Due to the special arrangement with several separate magnetic cores and the alternating magnetic field orientation, advantageous coupling properties furthermore arise between the primary and secondary windings, whereby a particularly low leakage inductance is achieved. This property improves in particular the dynamic behavior of the transformer, which makes it particularly suitable for applications in the field of power electronics, for example in high-frequency power converters, resonant converters, or in switched-mode power supplies.

In another further development of the stated inductive component, in cross-section the conductor has a height selected to be a multiple greater than its width. In this way, a significant reduction in electrical losses results due to an improved ratio between conductor surface and cross-section, whereby in particular the skin effect is minimized at higher frequencies. The electric current is thereby distributed over a larger vertical surface of the conductor, so that the effective conductivity increases and the heat loss is reduced. In addition, this conductor geometry enables space-saving integration into compact, modularly constructed inductive components, since several narrow conductors can be positioned next to one another without generating significant parasitic couplings.

In a special further development of the stated inductive component, the conductor is formed flat at its end faces, viewed in the width direction, in cross-section. In this way, with the same conductor cross-section, the available conductor surface can be optimized, whereby the electrical resistance is minimized and at the same time optimum use of the conductor cross-section with regard to current-carrying capacity and power loss is achieved. In addition, this geometry creates a defined and clearly delimited contact surface which makes possible later mechanical or thermal connection of the conductor within the inductive component in a flexible manner. As a result, the component can be adapted more easily to different structural requirements without already having to predetermine a concrete installation position or orientation.

In a preferred further development of the stated inductive component, a slot is formed between the magnetic cores, into which the conductor is inserted, viewed in cross-section, in the direction of its height. In this way, the available area of the slot is used particularly efficiently, since, by the orientation of the conductor in the direction of its height, a maximum cross-sectional area is realized with minimum space requirement in the width. This brings about a reduction in electrical resistance and electrical losses, since the conductor cross-section can be kept optimally large without at the same time increasing the overall dimensions of the arrangement. In addition, the mechanical stability of the conductor within the slot is improved because it is supported more stably in the height and is therefore less susceptible to mechanical loads or undesired movements. At the same time, this orientation facilitates the defined thermal and mechanical connection of the conductor to the surrounding magnetic cores or to further thermal elements for heat dissipation.

In a particularly preferred further development of the stated inductive component, the conductor is completely recessed in the slot, so that its outer contour does not project beyond the surfaces of the adjacent magnetic cores. In this way, magnetic stray fields are effectively reduced, since the conductors are completely surrounded by the core materials and the magnetic coupling between conductor and core is improved. At the same time, the space required is also reduced by the complete sinking of the conductor into the slot, which contributes to a particularly compact construction. The complete embedding additionally improves the mechanical and thermal stability by protecting the conductor and enabling efficient heat dissipation to the surrounding core material. In addition, the electromagnetic influence on adjacent components is considerably reduced by this construction, so that the inductive component can also be used particularly advantageously in environments with high EMC requirements.

In principle, the configuration of the open periodically curved geometry can be flexible, wherein this preferably comprises straight sections which are connected to one another by curved sections, wherein the at least one inflection point is arranged in one of the straight sections. In this way, clearly defined magnetic regions arise within the straight sections, in which the magnetically effective area of the conductor is used optimally and an approximately homogeneous magnetic field can be formed between the straight sections. This makes it possible to set the magnetic field distribution as well as the magnetic coupling between conductor and magnetic cores precisely and reproducibly, which contributes to improved electrical and magnetic efficiency of the inductive component.

In an additional further development of the stated inductive component, the conductor is configured such that the length of the straight sections is selected to be significantly greater, preferably by a multiple longer, in comparison with the curved sections. In this way, the idea of shortening the conductor lengths to reduce ohmic losses is implemented consistently.

In a further development, the stated inductive component comprises two magnetic flux guide plates, between which the magnetic cores are held in sandwich-like manner. The magnetic flux guide plates ensure a defined and uniform guidance of the magnetic flux, whereby undesired local saturation effects in the magnetic cores are reduced. Furthermore, these flux guide plates considerably improve the mechanical stability and integrity of the entire structure, since the magnetic cores are mechanically securely fixed and at the same time better protected against thermal and mechanical loads. From a thermal point of view, the flux guide plates also enable significantly improved heat dissipation by ensuring large-area thermal coupling and thus efficient dissipation of heat from the cores.

According to a further aspect of the invention, a method for manufacturing an inductive component comprises the steps of arranging a first magnetic core and a second magnetic core adjacent to the first magnetic core, inserting a conductor into an intermediate space between the first magnetic core and the second magnetic core, and laying the ends of the conductors emerging from the intermediate space around the first magnetic core and respectively the second magnetic core in such a way that an open periodically curved geometry with at least one inflection point is formed, such that, in the event of an electric current flowing through the conductor, the magnetic flux direction in the second magnetic core is oriented opposite to that in the first magnetic core.

In conventional inductive components, for example conventional coils or transformers, the magnetic core is typically made in one piece and provided with a fixed winding geometry. As a result, these components already have rigid and unchangeable inductive properties after their manufacture, which can later hardly be adapted to changed requirements.

The stated method addresses this with the proposal to realize an inductive component in modular form by providing at least two magnetic cores and a conductor with an open, periodically curved geometry. This modular construction allows the number of magnetic cores used as well as the position and arrangement of the conductor to be changed or expanded flexibly, and indeed possibly even directly on site during installation or during a subsequent adaptation.

In this way, a component is created whose inductive properties—such as inductance, magnetic coupling, or transformation ratio in the case of a transformer—can be adapted flexibly and easily as required by simply adding or removing individual modules. In addition to the increased flexibility and adaptability, considerable logistical and economic advantages arise therefrom, since storage, assembly, and maintenance costs are reduced. In addition, this modularity significantly improves maintainability, serviceability, and durability of the inductive components, since individual modules can be exchanged in a targeted manner without having to replace the entire component.

### BRIEF DESCRIPTION OF THE DRAWINGS

The properties, features, and advantages of this invention described above, as well as the manner in which these are achieved, become more understandable in connection with the following description of the exemplary embodiments, which are explained in more detail in connection with the drawing. Shown are:

FIG. 1, in a schematic illustration, a first exemplary embodiment of an inductive component from a perspective view,

FIG. 2a, in a schematic illustration, a sectional view of a second exemplary embodiment of an inductive component,

FIG. 2b, in a schematic illustration, a view of the inductive component of FIG. 2a without a cover plate.

In the figures, identical technical elements are provided with identical reference numerals and are described only once. The figures are purely schematic and above all do not reproduce the actual geometric relationships.

### DETAILED DESCRIPTION

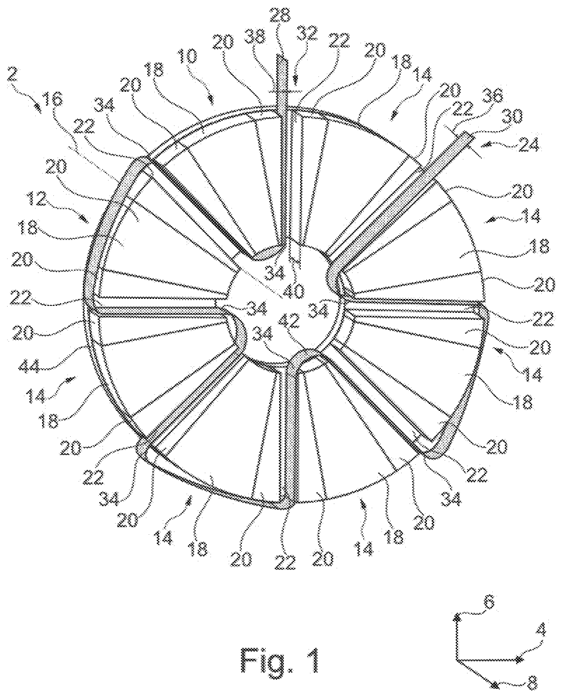

Reference is made to FIG. 1, which shows, in a schematic illustration, a first exemplary embodiment of an inductive component 2 from a perspective view. The inductive component 2 can in principle fulfill any electrotechnical function, for example as a transformer, as chokes, or in a complex device such as an electric motor as a flux transmission element.

For the sake of simplifying the further explanations, the inductive component 2 is considered in a space spanned by a longitudinal direction 4, a transverse direction 6 transverse to the longitudinal direction 4, and a height direction 8 transverse to the longitudinal direction 4 and transverse to the transverse direction 6.

The inductive component 2 is built up from several magnetic cores, of which in FIG. 1 a first magnetic core is referenced by reference numeral 10, a second magnetic core by reference numeral 12, and all other magnetic cores by reference numeral 14. A magnetic core is to be understood hereinafter as a structure consisting of a magnetically conductive material which serves for the targeted guidance and concentration of magnetic fluxes within an inductive component. The magnetic core forms the central component of the inductive component in that it improves the magnetic coupling between electrical windings and minimizes stray fluxes. It can consist of various materials, including ferrites, iron powder, or be formed as laminated electrical sheet metal, wherein the selection of the material and the geometry depends substantially on the magnetic properties necessary for the respective application of the inductive component 2, such as losses or frequency behavior.

In the embodiment of FIG. 1, the individual magnetic cores 10, 12, 14 are formed as circular segments with respect to a rotational axis 16 and are arranged with rotational symmetry such that an in-principle closed circle is formed. Each magnetic core 10, 12, 14 consists of a central core element 18, to which in and opposite to the circumferential direction around the rotational axis 16 one edge core element 20 is respectively applied.

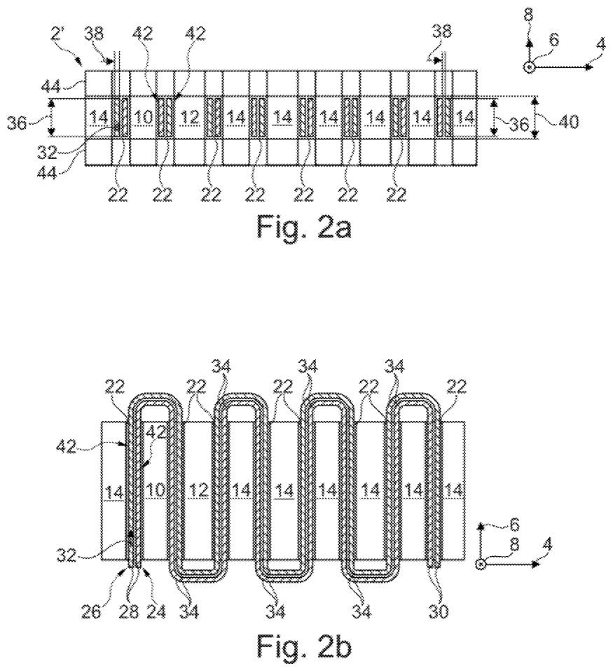

Viewed in the circumferential direction around the rotational axis 16, the individual magnetic cores 10, 12, 14 are spaced apart from one another by a gap or slot 22, into which a first conductor 24 is inserted. In principle, any number of conductors can be inserted into the slot 22, depending on the function of the inductive component 2. If the inductive component 2 is to be used, for example, as a transformer, then the second conductor 26 visible in FIG. 2 can also be inserted into the slot 22 shown in FIG. 1. The inductive component 2 shown in FIG. 1 with exclusively the first conductor 24 can be used, for example, as a rotor or stator in a transverse flux machine.

The first conductor 24 has a conductor start 28 and a conductor end 30 and is guided therebetween through the slots 22 of the magnetic cores 10, 12, 14, which leads to the serpentine course through the inductive component 2 that can be seen in FIG. 1. This serpentine course is characterized by an open periodically curved geometry in which the curvature of the first conductor 24 changes between the individual magnetic cores 10, 12, 14. The curvature of a component extending in a strand-like manner in a particular direction, such as here the first conductor 24, is to be understood hereinafter as a geometric property which describes how strongly the component deviates from a straight guide. A curvature is therefore present when the direction of the strandlike component changes continuously along its course instead of remaining straight. If, within the course, the direction of the curvature, seen from a particular perspective direction, reverses, i.e. changes from a curvature in one direction to a curvature in the opposite direction, then this is referred to as an inflection point.

For the explanation of curvature and inflection point, the first conductor 24 in FIG. 1 is viewed in the direction of the rotational axis 16. By way of illustration, a bicyclist can be viewed in the direction of the rotational axis 16 who travels along the path of the first conductor 24. Based on the assumption that, during straight-ahead travel, the bicycle has a handlebar neutral position of 0°, an inflection point, in the sense of the further explanations, is always present when the handlebar position changes from 0° into the positive or from 0° into the negative. Based on this understanding of an inflection point, and under the assumption that the first conductor 24 is supplied with an electric current flowing from the conductor start 28 to the conductor end 30, the inflection points on the first electrical conductor 24, viewed in the current flow direction 32, are located at the end of the straight sections of the electrical conductor 24 and, for the sake of clarity, are provided with the reference numeral 34.

The first conductor 24 can in principle be designed arbitrarily, for example as a round wire. The mechanical design is also arbitrary, for example as a solid wire or as a litz wire. In a particularly favorable manner, the first conductor 24 as well as the second conductor 26 shown in FIG. 2 is designed as a flat strip conductor and has a height 36 extending in the direction of the rotational axis 16 and thus the height direction 8, as well as, at right angles thereto and at right angles to the current flow direction 32, a width 38. The height 36 is selected such that it exceeds the width 38 by a multiple. For practical implementation, ratios of height 36 to width 38 between 20:1 and 40:1 have proven practical. Later measurements were carried out with a ratio of 37.5:1. The height 36 of the electrical conductor 24 is selected to be smaller than a depth 40 of the slots 22, which in FIG. 1, for the sake of clarity, is referenced by a reference numeral only at one location.

In principle, the electrical conductor 24 can be inserted into the slots 22 in any desired manner, i.e. also obliquely or lying down. In a particularly favorable manner, however, the electrical conductor 24 is inserted upright into the slots 22 and, depending on how the electrical conductor 24 is curved, in regions lies against one side 42 defining its height.

Depending on the mechanical and/or electrical requirements within the application of the inductive component 2, the magnetic cores 10, 12, 14 can be covered with flux guide plates 44, viewed in the height direction 8. If the inductive component 2 is used in a transverse flux machine, a covering from both sides, viewed in the height direction 8, is counterproductive and the inductive component 2 should be used as shown in FIG. 1.

When used as a transformer, however, two flux guide plates 44 should be used, which cover the magnetic cores 10, 12, 14 from above and below, viewed in the height direction 8, and thus form a closed magnetic circuit with as little stray loss as possible. Such an inductive component 2′, which is suitable for use as a transformer, is shown in FIGS. 2a and 2b, wherein in FIG. 2b the inductive component 2′ is shown, for the sake of clarity, without the upper flux guide plate 44 as viewed in the height direction 8.

In principle, the two embodiments can be interchanged with one another, that is, in FIG. 1 the second conductor 26 can be inserted and an upper flux guide plate 44 can be placed on top, and vice versa.

If the inductive component is used as a transformer, however, it should be noted that the current direction 32 defined in the context of FIG. 1 relates to the primary winding conductor, for which the first conductor 24 was selected in FIG. 2a.

### REFERENCE SIGNS LIST

2, 2 Inductive Component
4 Longitudinal Direction
6 Transverse Direction
8 Height Direction
10 First Magnetic Core
12 Second Magnetic Core
14 Other Magnetic Cores
16 Rotational Axis
18 Central Core Element
20 Edge Core Element
22 Slot
24 Electrical Conductor
26 Second Conductor
28 Conductor Start
30 Conductor End
32 Current Flow Direction
34 Inflection Point
36 Height of the Electrical Conductor
38 Width of the Electrical Conductor
40 Depth of the Slots
42 Side of the Electrical Conductor, Which Defines Its Height
44 Flux Guide Plate

1. An inductive component (2), comprising:
a first magnetic core (10),
a second magnetic core (12) arranged adjacent to the first magnetic core (10), and
a conductor (24) laid around the first magnetic core (10) and the second magnetic core (12) in an open periodically curved geometry with at least one inflection point (34), such that, in the event of an electric current flowing through the conductor (24), the magnetic flux direction in the second magnetic core (12) is oriented opposite to that in the first magnetic core (10).

2. The inductive component (2) according to claim 1, comprising a further conductor (26) laid parallel to the conductor (24) around the first magnetic core (10) and the second magnetic core (12).

3. The inductive component (2) according to claim 1, wherein, in crosssection, the conductor (24) has a width (38) and a height (36), the height being selected to be a multiple greater than the width (38).

4. The inductive component (2) according to claim 3, wherein the conductor (24) is formed flat at its end faces, viewed in the width (38), in crosssection.

5. The inductive component (2) according to claim 3, wherein a slot (22) is formed between the magnetic cores (10, 12, 14), into which the conductor (24) is inserted, viewed in cross-section, in the direction of its height (36).

6. The inductive component (2) according to claim 5, wherein, in crosssection, a depth (40) of the slot (22) is selected to be greater than the height (36) of the conductor (24).

7. The inductive component (2) according to claim 1, wherein the open periodically curved geometry comprises straight sections which are connected to one another by curved sections, the at least one inflection point (34) being arranged in one of the straight sections.

8. The inductive component (2) according to claim 7, wherein a length of the conductor (24) in the straight sections is selected to be a multiple greater than in the curved sections.

9. The inductive component (2) according to claim 1, comprising two magnetic flux guide plates (44), between which the magnetic cores (10, 12, 14) are held in sandwich-like manner.

10. A method for manufacturing an inductive component (2), the method comprising the steps of:
arranging a first magnetic core (10) and a second magnetic core (12) adjacent to the first magnetic core (10),
inserting a conductor (24) into an intermediate space between the first magnetic core (10) and the second magnetic core (12), and
laying the ends of the conductor (24) emerging from the intermediate space around the first magnetic core (10) and respectively the second magnetic core (12) in such a way that an open periodically curved geometry with at least one inflection point (34) is formed, such that, in the event of an electric current flowing through the conductor (24), the magnetic flux direction in the second magnetic core (12) is oriented opposite to that in the first magnetic core (10).
